(19) United States
(12) Patent Application Publication
(10) Pub. No.: US 2015/0353723 A1
(43) Pub. Date: Dec. 10, 2015

(54) REDUCTION OF BENZYL ALCOHOL EMISSIONS FROM EPOXY AMINE FORMULATIONS BY ADDING CYCLODEXTRIN

(71) Applicant: SIKA TECHNOLOGY AG, Baar (CH)

(72) Inventors: Kathrin BRACHT, Weil der Stadt (DE); Claus URBAN, Ludwigsburg (DE)

(21) Appl. No.: 14/759,835

(22) PCT Filed: Jan. 7, 2014
(86) PCT No.: PCT/EP2014/050114

§ 371 Date: Jul. 8, 2015

(30) Foreign Application Priority Data
Jan. 8, 2013 (EP) 13150552.1

(51) Int. Cl. C08L 63/00; C09D 163/00; C08L 75/04

(52) U.S. Cl. CPC C08L 63/00; C08L 75/04; C09D 163/00

(57) ABSTRACT

A reactive resin compositions include at least one polymerizable system, at least one volatile organic compound, cyclodextrin, and optionally at least one curing agent, which are obtainable by mixing the polymerizable system with the volatile organic compound and the cyclodextrin and storing the mixture for a period of time until an equilibrium is established between the volatile organic compound and the cyclodextrin. By adding cyclodextrin it is possible to reduce the VOC emissions of corresponding reactive resin compositions significantly, the observed effect being greater than would be expected on the basis of the molar ratio of the volatile organic compound to the cyclodextrin. The reactive resin composition can thus be used advantageously in applications such as coatings and/or sealants, in which the evaporation of organic compounds should be avoided.

### TECHNICAL FIELD

The present invention relates to reactive resin compositions, comprising at least one polymerizable system, at least one volatile organic compound, cyclodextrin and optionally at least one curing agent, which are obtainable by mixing the polymerizable system with the volatile organic compound and the cyclodextrin and storing the mixture for a period of time until an equilibrium is established between the volatile organic compound and the cyclodextrin.

Furthermore, the present invention relates to a method for producing such reactive resin compositions and their use as coating and/or sealant for substrates.

### PRIOR ART

Many products require the addition of volatile organic compounds in order to ensure certain properties, such as, for example, adequate viscosity or an attractive appearance. For example, benzyl alcohol is added to coating formulations in order to ensure good processing viscosity at low temperatures (about 15° C.). However, the addition of large amounts of volatile organic compounds is problematic because of their evaporation over time. Thus, the addition of such compounds usually results in increased VOC emissions (VOC=Volatile Organic Compound), which can be problematic when the molecules that are emitted in gas form may be harmful to health, or if they would lead to an undesirable odor. This is particularly problematic in coatings that are applied over a large area and where protection of the persons doing the processing is difficult to ensure. In this context, benzyl alcohol is used for example in floor coatings for lounges. In Germany, for example, floor coverings for lounges must be approved by the German Institute for Building Technology according to the AgBB scheme (committee for health assessment of construction products). For this purpose, specific limits must be complied with in terms of VOC emissions. In particular, for such applications it would therefore be desirable if the emissions of the volatile organic compounds could be reduced without having to refrain from using them in the compositions.

Coatings, in particular for use as floor coatings, for example for lounges, are often based on reactive resin compositions based on epoxy or polyurethane resins, as these materials have suitable processing properties, and, after curing, form smooth and very resistant coatings.

U.S. Pat. No. 4,711,936 describes in one example a coating liquid comprising a cyclodextrin clathrate with diethylenetriamine, a Bisphenol A-diglycidyl ether diepoxide, methyl ethyl ketone, methyl isobutyl ketone and toluene, which is applied to a steel plate, heated, and then left at room temperature.

JP 06-329982 relates to coating compositions containing a polyol, a polyisocyanate, a catalyst and cyclodextrin. In the examples, solvents such as methyl ethyl ketone and toluene are used.

U.S. Pat. No. 5,603,974 A1 relates to a method for preventing vapor transfer to an article by a barrier layer comprising a thermoplastic polymer and cyclodextrin, wherein the barrier layer is intended to prevent the passage of materials such as, e.g., hydrocarbons and monomers.

### DESCRIPTION OF THE INVENTION

There is a need for reactive resin compositions, in particular for use for coatings, which after and during curing have VOC emissions as low as possible.

In the context of the present invention it has surprisingly been found that the problems described above can be solved by the addition of cyclodextrin to a reactive resin composition which contains at least one volatile organic compound, wherein it is necessary to admix the cyclodextrin and the polymerizable system, and then to store the system for a period of time until an equilibrium is established between the volatile organic compound and cyclodextrin.

It is further surprising that other important properties such as chemical resistance, curing rate, water absorption, appearance and, optionally, conductivity of the coatings produced with cyclodextrin change only slightly or even improve over the corresponding coatings without cyclodextrin.

### Ways of Carrying Out the Invention

Accordingly, a first aspect of the present invention relates to a reactive resin composition, comprising at least one polymerizable system, at least one volatile organic compound, cyclodextrin and optionally at least one curing agent, which is obtainable by mixing the polymerizable system with the volatile organic compound and the cyclodextrin and storing the mixture for a period of time until an equilibrium is established between the liquid organic compound and cyclodextrin.

It is preferred for the reactive resin composition that the polymerizable system is based on epoxides and polyurethanes.

In a preferred embodiment, the composition is a one-component composition, preferably with a polymerizable system based on polyurethanes. However, the composition may also be a two- or multi-component composition, where it is convenient in these cases that at least one of the components is a curing agent component and the curing agent is stored separately from the polymerizable system. In the context of the present invention, it is particularly preferred if it is a two-component composition in which the polymerizable system is based on epoxides.

The type of cyclodextrin used in the present invention is not significantly limited. Thus, cyclodextrins used can be both unmodified cyclodextrins such as α-cyclodextrin, β-cyclodextrin or γ-cyclodextrin and modified cyclodextrins such as hydroxypropyl or methyl derivatives of the cyclodextrins mentioned. In addition, other cyclodextrins well-known from the prior art can be included in the reactive resin composition. The aforementioned cyclodextrins are available, for example, under the trade names Cavamax W6, Cavamax W7, Cavamax W8, Cavamax W6HP, Cavamax W7HP or Cavamax W7M from Wacker Chemie, Germany.

In the context of the present invention, it is preferred if the cyclodextrin is α-cyclodextrin. The best results in reducing emissions of volatile organic compounds were observed with this cyclodextrin.

In the context of the present invention, it is furthermore preferred if the cyclodextrin is present in the reactive resin composition in an amount of 1 to 15% by weight, preferably 2 to 12% by weight and most preferably about 5 to about 10% by weight, based on the total weight of the composition. With amounts of <1% by weight no significant reduction of emissions can be observed. The addition of more than 15% by weight of cyclodextrin to the reactive resin composition, however, leads to a significant change in its properties, which is not desirable. The best effects in terms of reducing emissions of volatile organic compounds have been found at contents ranging from 5 to 10% by weight.

As was explained above, the reactive resin composition is stored for a period of time following the addition of cyclodextrin until an equilibrium is established between the volatile organic compound and cyclodextrin. In this context, it is preferred to store the mixture of the at least one polymerizable system, the volatile organic compound and the cyclodextrin for a period of time of at least 48 h, particularly preferably at least 72 h, even more preferably at least 120 h, and most preferably at least 168 h.

In the context of the present invention, it is furthermore preferred if the polymerizable system is based on an epoxy resin having a compound of the general formula (A)₂B, in which A represents a glycidyl radical and B represents an organic radical, or comprising oligomers thereof, particularly preferably having a molecular weight ranging from 300 to 1000. The polymerizable system therefore comprises, for example, Bisphenol A diglycidyl ether (BADGE) and/or Bisphenol F diglycidyl ether (BFDGE). Alternatively or additionally, the polymerizable system according to the invention can also include other diepoxy compounds such as, for example, polypropylene glycol diglycidyl ether, polytetrahydrofuran diglycidyl ether, or diglycidyl ethers of dialcohols such as, for example, 1,4-dibutanediol, 1,6-hexanediol, neopentyl glycol, or cyclohexanedimethanol. It is also possible to include monoglycidyl or epoxy compounds in the polymerizable system according to the invention, such as, in particular, linear and branched C₁-C₁₈ alkyl glycidyl ethers (for example, C₁₂/C₁₄ alkyl glycidyl ethers, C₁₃/C₁₅ alkyl glycidyl ethers, 2-ethylhexyl glycidyl ethers), p-tert-butylphenol monoglycidyl ethers, o-cresyl glycidyl ethers, cashew nut shell liquid glycidyl ethers, or glycidyl esters of C₁-C₁₈ carboxylic acids.

Other epoxides that are useful in the polymerizable system include glycerol trigylcidyl ether, trimethylolpropane triglycidyl ether, polyglycerol-3-glycidyl ether, polyoxypropylene glycol triglycidyl ether, castor oil triglycidyl ether, pentaerithrol tetraglycidyl ether, castor oil polyglycidyl ether, adducts of Bisphenol A and epichlorohydrin, and polyglycidyl ethers of phenol-formaldehyde novolacs.

In the context of the present invention it is particularly preferred if the compound of the general formula (A)₂B is based on Bisphenol A, Bisphenol F or a mixture thereof. Furthermore, it is preferred that the polymerizable system contains one or more of these compounds.

As curing agents for the epoxides listed above, the polymerizable system may comprise one or more amines, preferably wherein the curing agent is a diamine or triamine. Usable polyamines may be selected from the following groups:

(1) aliphatic, cycloaliphatic or arylaliphatic diamines, for example, ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2,4- and 2,4,4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- and 1,4-diaminocyclohexane, bis-(4-aminocyclohexyl)-methane (H12-MDA), bis-(4-amino-3-methylcyclohexyl)-methane, bis-(4-amino-3-ethylcyclohexyl)-methane, bis-(4-amino-3,5-dimethylcyclohexyl)-methane, bis-(4-amino-3-ethyl-5-methylcyclohexyl)-methane (M-MECA), 3-aminomethyl-3,5,5-trimethylcyclohexane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis-(aminomethyl)-cyclohexane, 2,5(2,6)-bis-(aminomethyl)-bicyclo[2.2.1]heptane (NBDA), 3(4), 8(9)-bis-(aminomethyl)-tricyclo[5.2.1.0^{2,6}]decane, 1,4-diamino-2,2,6-trimethylcyclohexane (TMCDA), 1,8-menthanediamine, 3,9-bis-(3-aminopropyl)-2,4,8,10-tetraoxaspiro[5.5]undecane as well as 1,3- and 1,4-xylylenediamine;

(2) ether group-containing aliphatic diamines, for example, bis-(2-aminoethyl)-ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine and higher oligomers of these diamines, bis-(3-aminopropyl)-polytetrahydrofurans and other polytetrahydrofuran diamines having molecular weights ranging, for example, from 350 to 5200, as well as polyoxyalkylenediamines. The latter are typically products from the amination of polyoxyalkylene diols and are obtainable, for example, under the name Jeffamine® (from Huntsman), under the name Polyetheramin (from BASF) or under the name PC Amine® (from Nitroil). Particularly suitable polyoxyalkylenediamines are Jeffamine® D-230, Jeffamine® D-400, Jeffamine® D-2000, Jeffamine® D-4000, Jeffamine® XTJ-511, Jeffamine® ED-600, Jeffamine® ED-900, Jeffamine® ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, Jeffamine® EDR-104, Jeffamine® EDR-148, Jeffamine® EDR-176; Polyetheramin D 230, Polyetheramin D 400 and Polyetheramin D 2000, PC Amine® DA 250®, PC Amine® DA 400, PC Amine® DA 650 and PC Amine DA 2000®;

(3) aliphatic, cycloaliphatic or arylaliphatic triamines such as 4-aminomethyl-1,8-octanediamine, 1,3,5-tris-(aminomethyl)-benzene, 1,3,5-tris-(aminomethyl)-cyclohexane, tris-(2-aminoethyl)-amine, tris-(2-aminopropyl)-amine, tris-(3-aminopropyl)-amine;

(4) polyoxyalkylenetriamines, which typically constitute products from the amination of polyoxyalkylene triols and are available, for example, under the trade name Jeffamine® (from Huntsman), under the name Polyetheramin (from BASF) or under the name PC Amine® (from Nitroil), such as, for example, Jeffamine® T-403, Jeffamine® T-3000, Jeffamine® T-5000; Polyetheramin T403, Polyetheramin T5000; and PC Amine® TA 403, PC Amine® TA 5000;

(5) polyamines having secondary and primary amino groups, for example diethylenetriamine (DETA), dipropylenetriamine (DPTA), bis-hexamethylenetriamine (BHMT), 3-(2-aminoethyl)-aminopropylamine, N3-(3-aminopentyl)-1,3-pentanediamine, N5-(3-aminopropyl)-2-methyl-1,5-pentanediamine, N5-(3-amino-1 ethylpropyI)-2-methyl-1,5-pentanediamine;

(6) polyamines having tertiary amino groups, such as, for example, N,N′-bis-(aminopropyl)-piperazine, N,N-bis-(3-aminopropyl)-methylamine, N,N-bis-(3-aminopropyl)-ethylamine, N,N-bis-(3-aminopropyl)-propylamine, N,N-bis-C3-aminopropyl)-cyclohexylamine, N,N-bis-(3-aminopropyl)-2-ethylhexylamine, as well as the products from the double cyanoethylation and subsequent reduction of fatty amines derived from natural fatty acids, such as N,N-bis-(3-aminopropyl)-dodecylamine and N,N-bis-(3-aminopropyl)-tallow alkylamin, available as Triameen® Y12D and Triameen YT® (from Akzo Nobel);

(7) polyamines having secondary amino groups, such as N,N′-dibutylethylenediamine; N,N′-di-tert-butylethylenediamine, N,N′-diethyl-1,6-hexanediamine, 1-(1-methylethylamino)-3-(1-methylethylaminomethyl)-3,5,5-trimethylcyclohexane (Jefflink® 754 from Huntsman), N4-cyclohexyl-2-methyl-N2-(2-methylpropyl)-2,4-pentanediamine, N,N′-dialkyl-1,3-xylylenediamine, bis-(4-(N-alkylamino)-cyclohexyl)-methane, 4,4′-trimethylenedipiperidine, N-alkylated polyether amines, such as Jeffamine® types SD-231, SD-401, SD-404 and SD-2001 (from Huntsman);

(8) furthermore, so-called polyamidoamines. Polyamidoamine refers to the reaction product of a mono- or polyvalent carboxylic acid, or their esters or anhydrides, and an aliphatic, cycloaliphatic or aromatic polyamine, wherein the polyamine is used in stoichiometric excess. The polyvalent carboxylic acid used is usually a so-called dimer fatty acid, and the polyamine used is usually a polyalkylene amine such as, for example, TETA. Commercially available polyamidoamines are, for example, Versamid® 100, 125, 140 and 150 (from Cognis), Aradur 223, 250 and 848 (from Huntsman), Euretek® 3607, Euretek 530® (from Huntsman), Beckopox® EH 651, EH 654, EH 655, EH 661 and EH 663 (from Cytec); and

(9) reaction products which are obtained by reacting the amines mentioned above under (1) to (8) with a less than stoichiometric amount of epoxy compound (epoxy amine adducts).

Preferably, the amine curing agent is selected from the group consisting of 1,5-diamino-2-methylpentane (MPMD), 2-butyl-2-ethyl-1,5-pentanediamine (C11-Neodiamin), 2,2,4- and 2,4,4-trimethylhexamethylenediamine (TMD), bis-(4-amino-3-methylcyclohexyl)-methane, 3-aminomethyl-3,5,5-trimethylcyclohexane, 1-amino-3-aminomethyl-3,5,5-trimethylcyclohexane (=isophoronediamine or IPDA), 1,3-bis-(aminomethyl)-cyclohexane, 3(4), 8(9)-bis-(aminomethyl)-tricyclo[5.2.1.0^{2,6}]decane, 1,3-xylylenediamine, diethylenetriamine (DETA), dipropylenetriamine (DPTA), and an ether group-containing diamine from the amination of a polyoxyalkylene diol with a molecular weight of 500 to 5000 g/mol, in particular Jeffamine® D-230 and Jeffamine® D-400.

Other preferred amine curing agents are
polyamines having primary, secondary and tertiary amino groups such as Gaskamine A 229, Gaskamine 240, Gaskamine 328 (from Mitsubishi Gas Chemical); and
cashew nut shell liquid-based amines, for example, from the Phenalkamines Curing Agent Series of Cardolite Corporation.

For use in aqueous systems, modified amines and amides or polyamines and amides, inter alia, for example from the Anquamine® series from Air Products, the Aradur® series from Huntsman, the Polypox® W series from Dow.

If as polymerizable system an epoxy resin is used, in which an amine or a mixture of different amines is used as curing agent, suitably the cyclodextrin substantially completely (i.e., at least 90% by weight, preferably at least 95% by weight) is added to the epoxy component. The reason for this is that in some instances it could be observed that upon addition of the cyclodextrin to the amine component the latter thickened to such an extent that subsequent blending was possible only with difficulty.

If the polymerizable system is a system based on polyurethanes, polyoxyalkylene polyols, also called “polyether polyols”, polyester polyols, polycarbonate polyols and mixtures thereof can be used as the preferred polyols. The most preferred polyols are diols, in particular polyoxyethylene diols, polyoxypropylene diols or polyoxybutylene diols.

Suitable polyether polyols, also called polyoxyalkylene polyols or oligoetherols, include in particular those which are polymerization products of ethylene oxide, 1,2-propylene oxide, 1,3-propylene oxide, 1,2- or 2,3-butylene oxide, oxetane, tetrahydrofuran or mixtures thereof, optionally polymerized using a starter molecule having two or more active hydrogen atoms such as, for example, water, ammonia or compounds having several OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, Bisphenol A, hydrogenated Bisphenol A, 1,1,1-trimethylolethane, 1,1,1-trimethylolpropane, glycerol, aniline, and mixtures of the compounds mentioned. Both polyoxyalkylene polyols which have a low degree of unsaturation (measured according to ASTM D-2849-69 and reported in milliequivalent unsaturation per gram of polyol (meq/g)), produced, for example, using so-called double metal cyanide complex catalysts (DMC catalysts), and polyoxyalkylene polyols having a higher degree of unsaturation, produced, for example, using anionic catalysts such as NaOH, KOH, CsOH or alkali alcoholates may be used.

Particularly suitable are polyoxyethylene polyols and polyoxypropylene polyols, in particular polyoxyethylene diols, polyoxypropylene diols, polyoxyethylene triols and polyoxypropylene triols.

Particularly suitable polyoxyalkylene diols or polyoxyalkylene triols include those having a degree of unsaturation less than 0.02 meq/g and having a molecular weight ranging from 1,000 to 30,000 g/mol, as well as polyoxyethylene diols, polyoxyethylene triols, polyoxypropylene diols and polyoxypropylene triols having a molecular weight of 400 to 8,000 g/mol.

Likewise, so-called ethylene oxide-terminated (“EO endcapped”, ethylene oxide-endcapped) polyoxypropylene polyols are particularly suitable. The latter are special polyoxypropylene polyoxyethylene polyols which are obtained, for example, by further alkoxylating pure polyoxypropylene polyols, in particular polyoxypropylene diols and triols, with ethylene oxide after the polypropoxylation reaction is complete, and thus have primary hydroxyl groups. In this instance, polyoxypropylene polyoxyethylene diols and polyoxypropylene polyoxyethylene triols are preferred.

Also suitable are styrene-acrylonitrile-grafted polyether polyols, as are commercially available, for example, under the trade name Lupranol® from Elastogran GmbH, Germany.

Suitable polyester polyols include in particular polyesters which bear at least two hydroxyl groups and are produced by known methods, in particular by the polycondensation of hydroxycarboxylic acids or the polycondensation of aliphatic and/or aromatic polycarboxylic acids with di- or polyhydric alcohols.

Particularly suitable polyester polyols are those which are produced from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, trimethyl adipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the aforementioned acids, as well as polyester polyols from lactones such as ε-caprolactone.

Particularly suitable are polyester diols, in particular those which are produced from adipic acid, azelaic acid, sebacic acid, dodecanedicarboxylic acid, dimer fatty acid, phthalic acid, isophthalic acid and terephthalic acid as the dicarboxylic acid or from lactones such as ε-caprolactone and from ethylene glycol, diethylene glycol, neopentyl glycol, 1,4-butane diol, 1,6-hexane diol, dimer fatty acid diol and 1,4-cyclohexanedimethanol as the dihydric alcohol.

Particularly suitable polycarbonate polyols are those that can be obtained by reacting, for example, the above-mentioned alcohols that are used to synthesize the polyester polyols with dialkyl carbonates such as dimethyl carbonate, diaryl carbonates such as diphenyl carbonate or phosgene. Polycarbonate diols are particularly suitable, in particular amorphous polycarbonate diols.

Further suitable polyols include poly(meth)acrylate polyols.

Polyhydroxy functional fats and oils are also suitable, for example natural fats and oils, in particular castor oil, or so-called oleochemical polyols obtained by chemical modification of natural fats and oils, the epoxy polyesters or epoxy polyethers obtained, for example, by epoxidation of unsaturated oils and subsequent ring opening with carboxylic acids or alcohols, or polyols obtained by hydroformylation and hydrogenation of unsaturated oils. Furthermore, it includes polyols which are obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are in particular fatty acids and fatty alcohols and fatty acid esters, in particular the methyl esters (FAME), which can be derivatized, for example, by hydroformylation and hydrogenation to form hydroxy fatty acid esters.

Also suitable are furthermore polyhydrocarbon polyols, also called oligohydrocarbonols, for example, polyhydroxy-functional ethylene-propylene, ethylene-butylene or ethylene-propylene-diene copolymers, as produced, for example, by Kraton Polymers, USA, or polyhydroxy-functional copolymers made of dienes such as 1,3-butadiene or diene mixtures and vinyl monomers such as styrene, acrylonitrile or isobutylene, or polyhydroxy-functional polybutadiene polyols, for example those which are produced by copolymerization of 1,3-butadiene and allyl alcohol or by oxidation of polybutadiene, and which can also be hydrogenated.

Also suitable are polyhydroxy-functional acrylonitrile/butadiene copolymers, as can be produced, for example, from epoxides or amino alcohols and carboxyl-terminated acrylonitrile/butadiene copolymers (commercially available under the name Hypro® CTBN from Emerald Performance Materials, LLC, USA).

These polyols mentioned preferably have an average molecular weight of 250 to 30,000 g/mol, in particular from 1,000 to 30,000 g/mol, and an average OH functionality ranging from 1.6 to 3.

Particularly suitable polyols include polyester polyols and polyether polyols, in particular polyoxyethylene polyol, polyoxypropylene polyol and polyoxypropylene polyoxyethylene polyol, preferably polyoxyethylene diol, polyoxypropylene diol, polyoxyethylene triol, polyoxypropylene triol polyoxypropylene polyoxyethylene diol and polyoxypropylene polyoxyethylene triol and castor oil.

Suitable diisocyanates include, in principle, all diisocyanates. Examples include 1,6-hexamethylene diisocyanate (HDI), 2-methyl-pentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane-1,3-diisocyanate, cyclohexane-1,4-diisocyanate, 1-isocyanato-3,3,5-trimethyl-5-isocyanatomethyl-cyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)-naphthalene, 2,4- and 2,6-toluene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanato-benzene, naphthalene-1,5-diisocyanate (NDI), 3,3′-dimethyl-4,4′-diisocyanatodiphenyl (TODI); oligomers and polymers of the aforementioned isocyanates, and any mixtures of the aforementioned isocyanates.

In addition, the polymerizable system may comprise further components such as, in particular, pigments, pigment pastes and/or fillers, which may be preferably selected from the group consisting of heavy spar (BaSO₄), calcium carbonate, dolomite, calcium sulfate, talc, kaolin, mica, feldspar, wollastonite, aluminum silicate, zirconium silicate, silicon dioxide in the form of sand, quartz, quartz powder, quartzite, perlite, glass beads; aluminum hydroxide, carbon blacks, graphite powder, synthetic fibers, as well as antioxidants, leveling or thickening agents, defoamers/deaerators and/or wetting agents, electrolyte salts, reactive diluents, solvents, preservatives and plasticizers or mixtures thereof.

The present invention is also not subject to any significant limitations with regard to the volatile organic compounds, however it is preferred that the volatile organic compound is benzyl alcohol.

The content of the volatile organic compound in the mixture ranges preferably from about 1 to 30% by weight, and particularly preferably from 2 to 15% by weight, based on the total weight of the reactive resin composition. It is further preferred, if the molar ratio of the volatile organic compound to cyclodextrin in the composition ranges from 50:1 to 5:1, in particular from 20:1 to 7:1, and particularly preferably from 15:1 to 8:1.

A further aspect of the present invention relates to a process for producing a reactive resin composition, comprising mixing a polymerizable system, a volatile organic compound and cyclodextrin in a container and then storing the mixture for a period of time until an equilibrium is established between the cyclodextrin and the volatile organic compound, thereby obtaining a composition, and optionally charging a separate container with at least one curing agent.

The present invention also relates to the use of cyclodextrin for reducing emissions of volatile organic compounds, in particular benzyl alcohol emissions, from a reactive resin composition, wherein the cyclodextrin is added to a reactive resin composition containing a volatile organic compound, and the mixture is stored, until an equilibrium is established between the cyclodextrin and the volatile organic compound.

Finally, another aspect of the present invention relates to the use of a reactive resin composition, as described above, as coating and/or sealant, in particular as an adhesive, sealant, laminating, impregnating or casting resin, potting compound or putty, composite, fiber composite material and model building material, wherein any optionally present individual components are mixed and the composition is applied to a substrate. Coatings include, in particular, floor coatings for living areas, lounges, public buildings such as, for example, schools, kindergartens, government buildings, hospitals, industrial buildings, factories and warehouses, passageways and connecting routes, industrial sites, workshops, clean rooms, parking lots, parking garages and decks, and bridges. It may include also coatings for tanks, sumps, cooling towers, pipes, for waterproofing roofs, basements, containers, for example, for drinking water, swimming pools, wastewater treatment plants, as well as coatings for corrosion, flame and acid protection of metallic and other surfaces and substrates.

### EXAMPLES

Hereinafter, the present invention will be illustrated by way of a few examples, which are not intended to limit the scope of the present application in any way.

### Example 1

Various amounts of cyclodextrin were mixed with the component A (containing the epoxy component) of Sikafloor®-264 and stored for three days, until an equilibrium is established between the cyclodextrin and the benzyl alcohol contained in component A. Subsequently, component A was mixed with an amine component (component B) consisting of a 1:1 mixture of isophorone diamine and m-xylenediamine, and cured. The emission rate after 31 days after curing was determined and compared to the emission rate of a comparative sample to which no cyclodextrin was added. The results for these tests are shown in Table 1 below.

TABLE 1

| | | | | Reduction |
|---|---|---|---|---|
| | | | % by weight | to % of |
| | Emitted | | relative to | reference |
| Sikafloor | substance | Cyclodextrin | AB | (31 d) |
| 264 | Benzyl alcohol | α-Cyclodextrin | 2 | 85 |
| 264 | Benzyl alcohol | α-Cyclodextrin | 5 | 45 |
| 264 | Benzyl alcohol | α-Cyclodextrin | 10 | 55 |
| 264 | Benzyl alcohol | β-Cyclodextrin | 5 | 85 |
| 264 | Benzyl alcohol | β-Cyclodextrin | 10 | 85 |
| 264 | Benzyl alcohol | γ-Cyclodextrin | 5 | 85 |
| 264 | Benzyl alcohol | γ-Cyclodextrin | 10 | 70 |

It was found that with cyclodextrin α, β, and γ a significant reduction of the benzyl alcohol emissions to 45% of the reference (without cyclodextrin) can be achieved. All cyclodextrins employed led to a reduction of the benzyl alcohol emission compared to the reference. The best results could be observed with a-cyclodextrin (addition of 5 or 10%).

The experiments also showed that with the addition of cyclodextrin to the amine component, undesirable thickening of the curing agent occurred, so that homogeneous blending no longer was possible.

It has also been found that, when A and B were mixed directly after the addition of the cyclodextrin (i.e., without prior storage) no reduction in emissions could be observed.

It was surprising, however, that the reduction of the benzyl alcohol emission is more pronounced than can be explained by complexation of cyclodextrin with benzyl alcohol in the ratio 1:1 (see Table 2.).

TABLE 2
Content of BzOH in SR 264

| BzOH content in Sikafloor ® 264 | 2% | 5% | 10% |
|---|---|---|---|
| g α-CD/100 g (AB) | 2 | 5 | 10 |
| mmol α-CD/100 g (AB) | 2.06 | 5.14 | 10.28 |
| % free BzOH* | 98 | 94 | 89 |
| Emission reduction to % after 6 d | 95 | 88 | 65 |
| (approximately) | | | |

*Assumption: Each cyclodextrin molecule incorporates exactly one BzOH molecule

It has further been found that the addition of α-cyclodextrin does not adversely impact the cure rate, chemical resistance and water absorption of Sikafloor®-264. Testing of the chemical resistance with the usual test liquids according to a simplified evaluation scheme on coatings did not show any differences between the cyclodextrin-containing coatings compared to reference coatings that do not contain cyclodextrin.

With respect to the water absorption, the weight increase for the above examples with 5% or 10% α-cyclodextrin in component A was determined relative to a reference without α-cyclodextrin in component A in each case after 28 days of curing at 23° C. and 50% relative humidity. The following results were obtained:

| | Weight increase [%]* | | |
|---|---|---|---|
| | after 1 d | after 2 d | after 7 d |
| Sikafloor ®-264 | 0.41 | 0.60 | 0.92 |
| Sikafloor ®-264 + 5% cyclodextrin in | 0.34 | 0.53 | 0.53 |
| component A | | | |
| Sikafloor ®-264 + 10% cyclodextrin in | 0.37 | 0.52 | 1.12 |
| component A | | | |

*Average of triplicate measurement

The water absorption of the cyclodextrin-containing formulations is lower than that of the reference.

### Example 2

The epoxy component of the product Sikafloor®-2530W (component A) was mixed with different amounts of α-cyclodextrin. Sikafloor®-2530W is a water-based product. The mixture was stored at room temperature for 7 d. Another set of samples was cured immediately after mixing the epoxy component with the cyclodextrin with the amine component (component B). Emissions of benzyl alcohol were determined as described in Example 1. The results of these measurements are shown in the following Table 3:

TABLE 3

| | | | | Reduction |
|---|---|---|---|---|
| | | | % by weight | to % of |
| | Emitted | | relative | reference |
| Sikafloor | substance | Cyclodextrin | to AB | (31 d) |
| 2530W | Benzyl alcohol | α-Cyclodextrin | 2 | 88 |
| 2530W | Benzyl alcohol | α-Cyclodextrin | 5 | 80 |
| 2530W | Benzyl alcohol | α-Cyclodextrin | 10 | 30 |

It was found that even with this product a significant reduction of the benzyl alcohol emissions could be observed. Upon addition of 10% by weight of α-cyclodextrin to the total mixture (after storage for 7 d), a reduction of the benzyl alcohol emissions to 30% of the reference could be observed. However, in experiments in which the components A and B were mixed directly after the addition of cyclodextrin to component A, no reduction of the benzyl alcohol emissions was found.

### Example 3

The epoxy component of the product Sikafloor®-235 ESD (component A) was mixed with various amounts of α-cyclodextrin. Sikafloor®-235 ESD is used to produce charge-dissipative coatings. The mixture was stored for 7 d at room temperature and then cured with the amine component (component B). The emissions of benzyl alcohol were determined as described in Example 1. The results of these measurements are shown in the following Table 4:

TABLE 4

| | | | | Reduction |
|---|---|---|---|---|
| | | | % by weight | to % of |
| | Emitted | | relative | reference |
| Sikafloor | substance | Cyclodextrin | to AB | (31 d) |
| 235 ESD | Benzyl alcohol | α-Cyclodextrin | 5 | 84 |
| 235 ESD | Benzyl alcohol | α-Cyclodextrin | 10 | 57 |
| 235 ESD | Benzyl alcohol | α-Cyclodextrin | 15 | 46 |
| 235 ESD | Benzyl alcohol | α-Cyclodextrin | 20 | 52 |
| 235 ESD | Benzyl alcohol | α-Cyclodextrin | 25 | 52 |

It was found that with this product also a significant reduction in benzyl alcohol emissions could be observed. Upon addition of 15% by weight of a-cyclodextrin to the total mixture (after storage for 7 d), a reduction of the benzyl alcohol emissions to 46% of the reference could be observed.

The conductivity of Sikafloor®-235 ESD is hardly affected by the cyclodextrin, as is the water absorption of the free films. When storing coated glass in water, the reference coating without cyclodextrin detaches after two weeks, the films with 5% and 10% cyclodextrin only after three weeks. The films with 15%, 20% and 25% cannot be scraped off with a finger, even after three weeks in water.

1. A reactive resin composition, comprising:
at least one polymerizable system;
at least one volatile organic compound; and
cyclodextrin, the reactive resin composition obtainable by mixing the polymerizable system with the volatile organic compound and the cyclodextrin and storing the mixture for a period of time until an equilibrium is established between the volatile organic compound and the cyclodextrin.

2. The reactive resin composition according to claim 1, wherein the polymerizable system is based on epoxy resins or polyurethanes.

3. The reactive resin composition according to claim 1, wherein the composition is a one-component composition, preferably with a polymerizable system that is based on polyurethanes.

4. The reactive resin composition according to claim 19, wherein the composition is a two- or multi-component composition, wherein preferably the at least one curing agent is stored separately from the polymerizable system.

5. The reactive resin composition according to claim 1, wherein it has cyclodextrin in an amount of 1 to 15% by weight, preferably 2 to 12% by weight, and in particular 3 to 10% by weight, and most preferably 5 to 10% by weight, based on the total weight of the composition.

6. The reactive resin composition according to claim 1, wherein the cyclodextrin is present in the form of α-cyclodextrin.

7. The reactive resin composition according to claim 1, wherein the mixture of the at least one polymerizable system, the volatile organic compound and the cyclodextrin is stored for a period of time of at least 48 h, in particular at least 72 h, preferably at least 120 h, and most preferably at least 168 h.

8. The reactive resin composition according to claim 1, wherein the polymerizable system is based on an epoxy resin having a compound of general formula (A)₂B, in which A represents a glycidyl radical and B represents an organic radical, or comprising oligomers thereof, preferably having a molecular weight ranging from 300 to 1000.

9. The reactive resin composition according to claim 8, wherein the compound of the general formula (A)₂B is based on Bisphenol A, Bisphenol F or a mixture thereof.

10. The reactive resin composition according to claim 1, wherein the volatile organic compound is contained in the mixture with a content of 1 to 30% by weight, preferably 2 to 15% by weight.

11. The reactive resin composition according to claim 1, wherein the molar ratio of the volatile organic compound to the cyclodextrin in the composition ranges from 50:1 to 5:1, in particular from 20:1 to 7:1 and particularly preferably from 15:1 to 8:1.

12. The reactive resin composition according to claim 1, wherein the volatile organic compound is benzyl alcohol.

13. A process for producing a reactive resin composition, comprising:
mixing a polymerizable system, a volatile organic compound and cyclodextrin in a container and then storing the mixture for a period of time until an equilibrium is established between the cyclodextrin and the volatile organic compound, thereby obtaining a composition.

14. A method for reducing emissions of volatile organic compounds from a reactive resin composition comprising:
adding cyclodextrin to a reactive resin composition containing a volatile organic compound and storing the mixture until an equilibrium is established.

15. A cooling and/or sealant comprising the reactive resin composition according to claim 1, wherein any individual components which may be present are mixed, for application to a substrate.

16. The reactive resin composition according to claim 2, wherein the composition is a one-component composition, preferably with a polymerizable system that is based on polyurethanes.

17. The reactive resin composition according to claim 2, wherein the cyclodextrin is present in the form of α-cyclodextrin.

18. The reactive resin composition according to claim 3, wherein it has cyclodextrin in an amount of 1 to 15% by weight, preferably 2 to 12% by weight, and in particular 3 to 10% by weight, and most preferably 5 to 10% by weight, based on the total weight of the composition.

19. The reactive resin composition according to claim 1, comprising:
at least one curing agent.

20. The process for producing a reactive resin composition according to claim 13, comprising:
charging a separate container with at least one curing agent.
